(19) United States
(12) Patent Application Publication
(10) Pub. No.: US 2007/0204007 A1
(43) Pub. Date: Aug. 30, 2007

(54) Centralized processing and management system

(76) Inventors: Shahpour Ashaari, Bethesda, MD (US); William S. Nordling, Merrifield, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/707,134

(22) Filed: Feb. 16, 2007

Related U.S. Application Data
(60) Provisional application No. 60/773,637, filed on Feb. 16, 2006.

(51) Int. Cl. G06F 15/16

(52) U.S. Cl. 709/217

(57) ABSTRACT

A centralized processing and management system includes mail processing equipment, a central server, and a client, all of which may communicate via a network. Performance and event information from the mail processing equipment may be received at the central server. The performance and event information may be monitored, stored, reported, and made available to the client. The client may provide relevant information to users via an input/output device, and users may provide instructions to the client. The client may provide the instructions to the central server and the mail processing equipment.

### CROSS-REFERENCE TO RELATED APPLICATION

This patent application claims the benefit of priority from U.S. Provisional Patent Application No. 60/773,637, entitled CENTRALIZED PROCESSING AND MANAGEMENT SYSTEM, filed on Feb. 16, 2006, the entirety of which is incorporated herein by reference.

### DESCRIPTION

1. Technical Field

This disclosure is directed to the field of centralized processing of information, and more particularly, to the field of centralized processing and management of information from delivery item processing equipment within and across processing plants.

2. Background

Over the years, delivery item distribution technology has evolved to produce more advanced and robust processing equipment, such as Mail Processing Equipment (“MPE”). With recent technological advancement in the distribution technology sector, there exists the need to further automate processing, reduce cost, improve efficiency, and increase MPE performance. By leveraging a common set of hardware and software components, MPE computing functions can be redesigned to accomplish any of these benefits.

Classes of MPEs may perform a variety of functions, such as processing, sorting, or scanning mail. For example, one class of MPEs may consist of automated equipment for processing letter or flat mail. Within each MPE exists a computing environment. The MPE computing environment serves as a machine-controlled system and an interface between man and machine. If a processing plant happens to have ten MPEs for processing letter or flat mail, and each MPE has a separate computing environment, the letter or flat mail processing functions may be replicated on every single MPE. Even MPEs of different types share some functions in common that may be replicated on every MPE. In order to start processing mail, an operator must separately identify and run the mail processing function on ten individual MPEs.

While useful, currently available MPE computing environments may be improved to better meet the needs of consumers, as well as delivery service providers such as the United States Postal Service. For example, control of and interaction with MPEs is currently restricted to their physical location. To begin processing mail, an operator must be physically present on a plant floor in order to initiate processing of mail for each machine. This process may cause delays in mail processing, as well as the added expense of labor required for MPE operation. Further, multiple MPEs cannot be supervised and controlled simultaneously.

Additionally, dynamic and historical data (e.g., status, alarms, report statistics, and performance indicators) is already being collected and stored on each MPE, but no one capitalizes on that data because it is not collected in a central location. Furthermore, because data is collected using different data architectures and implementation technology, the information is sometimes inaccessible to other applications, as it is encased behind a custom user interface.

Another drawback of conventional MPEs is that maintenance of MPE computing hardware requires individual monitoring of computing hardware failures on a plant floor. Many units perform identical or near-identical functions, and each unit is expensive to procure, operate, and maintain. MPE computing software requires frequent upgrades, which must be performed individually on each machine type.

Conventional MPEs also sit on the dusty plant floor, and the dust causes frequent hardware failures in MPE computing equipment.

Yet another drawback of conventional MPEs is the development cost of configuring applications at design-time, rather than at run-time. For example, conventional MPE computing environments require custom code generation. The unique look and feel of custom applications adds time and complexity to software development and training.

It is therefore desirable to implement distributed technology computer architecture to monitor, control, process, and manage the flow and exchange of data between workroom floor operations and equipment, and plant and enterprise management applications. It is also desirable to consolidate computing hardware and their management functions (for example, supervisory and maintenance) into a centralized computing environment. It is also desirable to consolidate character recognition functions into a centralized computing environment.

### SUMMARY

In accordance with the invention, a system for centralized processing and management of information includes mail processing equipment, a central server, and a client. The central server has a receiver that is configured to receive at least one of performance and event information from the mail processing equipment. The central server also has a database configured to store the information and a transmitter configured to make available the information. The client includes an interface configured to receive the information and communicate instructions over a network.

### BRIEF DESCRIPTION OF THE DRAWINGS

FIG. 1 is a diagram of the components in an exemplary centralized processing system consistent with the present invention;

FIG. 2 is a diagram of the components in an exemplary mail processing equipment consistent with the present invention;

FIG. 3A is a diagram of the components in an exemplary central server consistent with the present invention;

FIG. 3B is a diagram of the information architecture in an exemplary central server consistent with the present invention;

FIG. 4 is a diagram of exemplary clients consistent with the present invention;

FIG. 5 is an exemplary chart of the functions in a centralized processing system consistent with the present invention;

FIG. 6 is a diagram of the components in an exemplary centralized mail processing system consistent with the present invention;

FIG. 7 is a diagram of an exemplary computing system consistent with the present invention; and

FIG. 8 is a flow diagram of exemplary steps performed by the central server to process event information consistent with the present invention.

### DETAILED DESCRIPTION

Reference will now be made in detail to exemplary embodiments of the invention, examples of which are illustrated in the accompanying drawings. Wherever convenient, the same reference numbers will be used throughout the drawings to refer to the same or like parts.

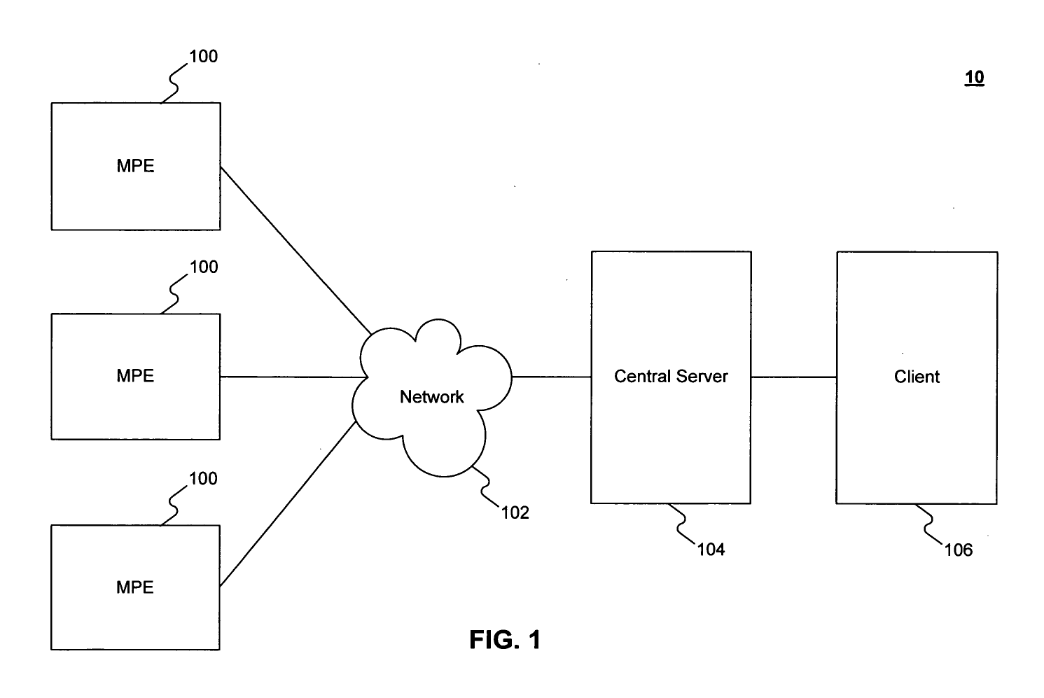

FIG. 1 illustrates a system 10 consistent with the present invention. One or more delivery item processors (such as MPEs 100), a central server 104, and a client 106 (which may be geographically diverse) are connected in a network configuration represented by a network cloud 102 or wide area network (WAN) configuration. The composition and protocol of the network configuration represented in FIG. 1 is not critical, as long as it allows for communication of information between MPEs 100, central server 104, and client 106. In addition, the use of three MPEs is merely for illustration and does not limit the present invention to the use of a particular number of delivery item processors. Central server 104 may also consist of multiple servers that can communicate with each other via a network. Client 106 may include a monitoring screen, an automation software component, an application interface, and/or an end user device. Client 106 may, through a near real-time interface, receive event information and communicate messages, requests, data, etc. over the network. Any number of clients 106 may be connected to a single central server 104.

Some functions may remain local to each MPE 100, some data may be stored temporarily at each MPE 100, and some data may be sent to the central server 104 and/or client 106 while remaining accessible at each MPE 100. Functions that remain local to each MPE 100 may include, for example, real-time control; data recording and uploading; user communication for operation and maintenance; monitoring and alarming; and supervisory control, including configuration, commanding, and control logic. Real-time state and mailpiece data, for example, may be stored temporarily at each MPE 100 for later transmission. Some historical maintenance data, for example, may be transmitted to the central server 104 and/or client 106 while remaining accessible at each MPE 100. Other data may remain stored on each MPE as well.

Other functions and data may be centralized on the central server 104 and/or client 106. Centralized functions may include, for example, configuration functions, monitoring and alarming functions, operations functions, security functions, or other functions for which remote access may be useful. Configuration functions such as sort plan maintenance, loading, selection, setting of configurable process elements like thresholds and modes, and operating plan maintenance may be centralized. Among the potentially centralized monitoring functions are current, trended, and historical displays; dynamic event/alarm notification; and summaries and report generation. Centralized operations functions may include, for example, operator messaging, emergency shutdown, and automatic update of maintenance data. Finally, the security function of monitoring access and logins may be centralized.

Data that may be centralized on the central server 104 and/or client 106 may include, for example, sort plans; directories; configuration data for MPEs 100; plant configuration data such as network planning and operations planning; operational performance data and maintenance data including current, trended, and historical data; mailpiece data; metadata for interface support; and other data that may be useful to access remotely.

Some of the functions and data that may be centralized may also be accessible between different plants.

Centralizing MPE functions may offer a number of advantages. For instance, centralization may reduce the cost of procuring, operating, and maintaining many MPE computing environments performing identical or near-identical functions. Centralization may also reduce the cost of procuring, operating, and maintaining multiple types of computing hardware and software. Centralized architecture may enhance the reliability of MPEs, as hardware failures due to exposure to the plant floor may be reduced. Additionally, a common, standard framework may facilitate future system evolution, and there may be greater flexibility and control in modifying centralized functions. Centralization may enable real-time performance monitoring, alerting, centralized scheduling, planning of operations, and maintenance tasks. Centralization may allow plant personnel to have increased access to information through a central server 104. Finally, centralization may streamline plant mail processing operations.

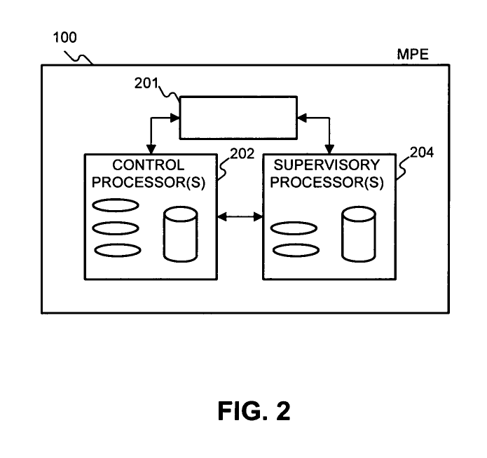

FIG. 2 is a diagram of the components of an MPE 100 consistent with an implementation of the present invention. MPE 100 may include mechanical components 201 under control of a control processor 202 and a supervisory processor 204. Supervisory processor 204 may function to provide a user interface for operator control and status reports, monitor the control processor 202, and provide overall machine monitoring, control, and maintenance functions. The supervisory processor 204 may also provide the network input/output interface. Control processor 202 may maintain real-time activities of MPE 100. For instance, control processor 202 may log the exact location of a mailpiece.

MPE 100 may run on an operating system such as Microsoft™ Windows, RedHat™ Enterprise Linux, RedHat™ Fedora Core, Sun Microsystems™ Solaris, or any other operating system. Preferably all MPEs 100 run on the same operating system, allowing them all to run the same applications.

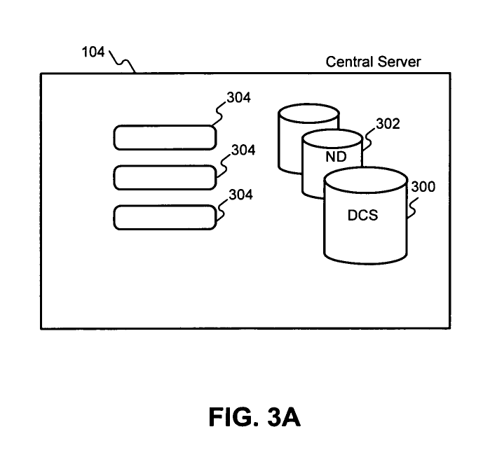

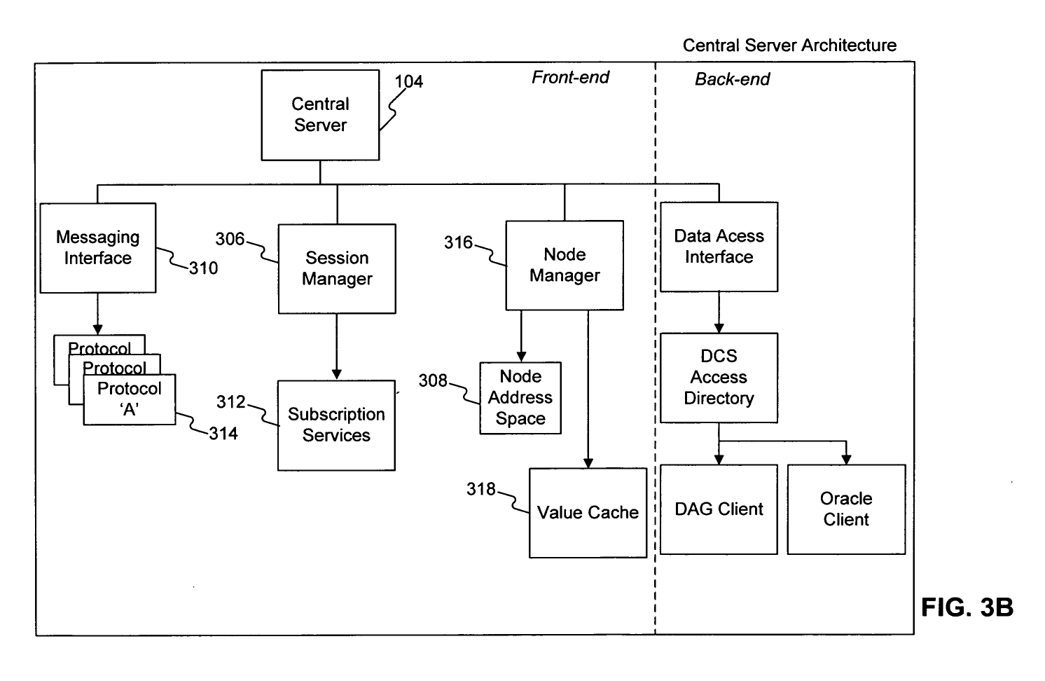

FIG. 3A is a diagram of the components in an exemplary central server 104 consistent with the present invention. Central server 104 may use resources to access a data collection server (“DCS”) database 300, a national directory generation database 302, and one or more applications 304 for managing MPEs. DCS database 300 may provide access to the following data sets: machine lists, real-time data point performance values, real-time event notifications, mailpiece data, unit load data, zip density, and other data sets. National directory generation database 302 maintains a national directory of addresses for optical character recognition technology services. Central server 104 may also maintain a database to store mailpiece volume data, so predictions can be made about mailpiece volume for geographically diverse processing and distribution centers.

Central server 104 may be located in a control room, separate from the plant floor. This remote location prevents dust from entering the computer hardware and breaking it.

Central server 104 may run on an operating system such as Microsoft™ Windows, RedHat™ Enterprise Linux, RedHat™ Fedora Core, Sun Microsystems™ Solaris, or any other operating system. Preferably central server 104 runs on the same operating system as MPE 100, allowing them to run the same applications.

FIG. 3B depicts the components of the software architecture of central server 104. The components are exemplary, as many different components may be added, changed, or substituted. The session manager component 306, for example, may maintain the session state for a single client 106. A client 106 may subscribe to one or more data elements through the subscription services 312 of its session. The messaging interface 310 may map to one or more underlying protocols 314 that may be MMS, XML technology-based, or a specific binary implementation such as OPC Unified Architecture. The node manager 316 may map the node address space 308 (to be discussed later) of the underlying system onto the data model that is being used. Data values obtained from the back-end data access interface may be stored in a value cache 318 for fast updates on client 106 read requests.

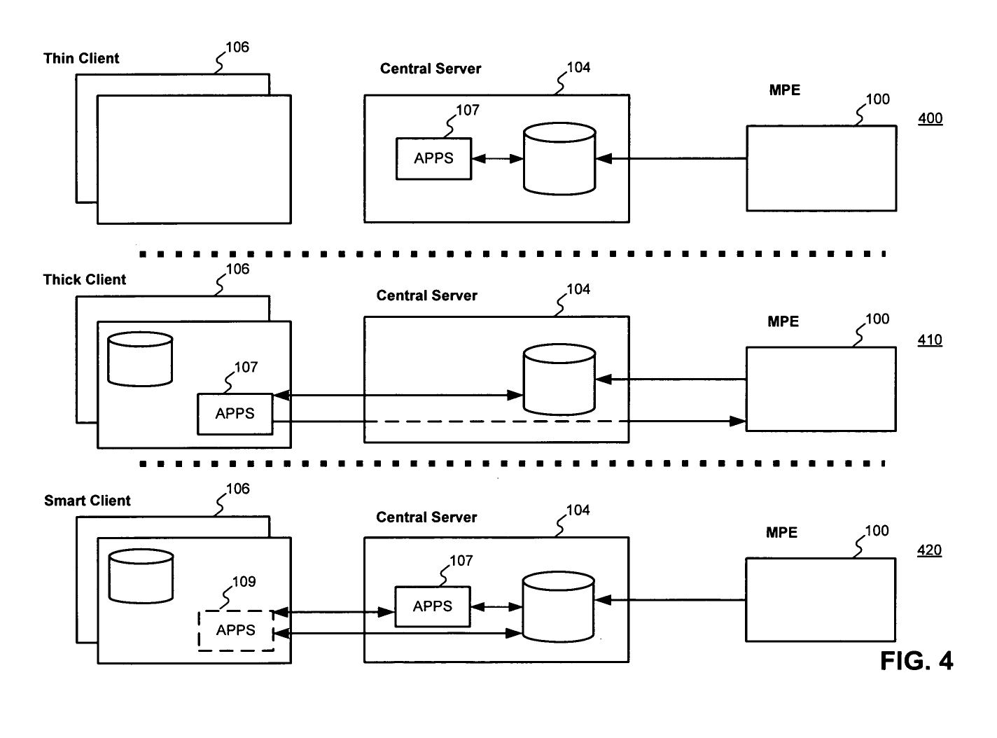

FIG. 4 is a diagram of exemplary clients 106 consistent with the present invention. Client 106 may consist of a standard browser (the “thin” client shown in system 400), a desk-top client (the “thick” client shown in system 410), or an agent (the “smart” client shown in system 420). The smart client of system 420 may consist of a portable client such as a Blackberry™, Palm Pilot™, cellular telephone, laptop computer with a wireless network card, laptop computer connected to a designated website, specialized receiving system in a delivery vehicle, satellite radio, GPS device, PDA, or other mobile device that is capable of receiving and storing data. In a preferred embodiment, a thin client is used for general performance monitoring applications, a thick client is used for centralized supervisory control functions, and a smart client is used for portable applications for maintenance technicians and user-specific notification and monitoring tools. For example, maintenance technicians could have access to remote alerts, maintenance records, and trending of data, among other things, to solve problems as they arise.

Client applications 107 and 109 may include a configuration management application (“CMA”), a performance management application (“PMA”), and a fault management application (“FMA”). Each of the CMA, PMA, and FMA may interact with a configuration server, and the configuration server application provides a view into all of the configurable, static information associated with each MPE 100. This server allows controlled access to command interfaces, including sort plan selection.

The CMA addresses the machine configuration needs of the supervisor of distribution operations. The CMA may allow the supervisor of distribution operations to view and modify the configuration settings of a group of MPEs 100. The CMA may interface with the configuration server to view and modify configuration data, and with a plan server to view sort plan and operating plan data. The plan server may provide a view into the strategic planning process for plant operations. This may include the logic for supporting the execution of the operating plan and the related sort plans as well as access to historical data for strategic planning. The plan server may also maintain dynamic state information associated with the progress of the operating plan.

The PMA may meet the needs of the manager of distribution operations for the entire plant and the supervisor of distribution operations for a group of MPEs 100. The PMA may provide a view into the operational performance of the plant and MPEs 100. The PMA may interface with a real-time data server to allow the continuous monitoring of statistical data, the review of historical data, and the monitoring and reception of alarm and events related to operational performance. The real-time data server may provide a view into the dynamic operational and equipment data collected from the MPEs 100. The real-time data server may interact with the DCS 300 to access the DCS 300 performance and machine status tables.

The FMA may provide a view into the physical status of MPEs 100. The FMA may be targeted to meet the needs of the maintenance supervisor and technician. The FMA may interface with the configuration server to view current machine configuration settings, and with the real-time data server to allow the continuous monitoring of statistical equipment performance data and the monitoring and reception of alarm and events related to equipment physical state. The FMA may interact with a maintenance logs data server to allow the review of historical maintenance data and documentation.

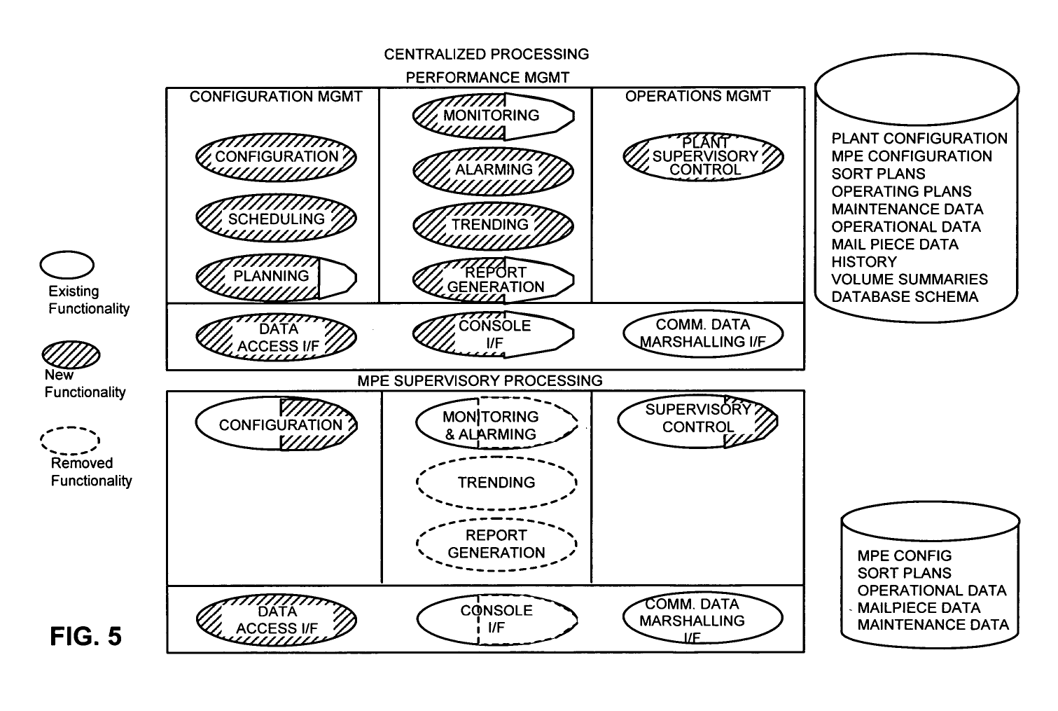

FIG. 5 is an exemplary chart of the functions in a centralized processing system consistent with the present invention. Several functions, such as MPE configuration management, sort planning, operational data management, mailpiece data management, and maintenance data management may be accessible via client 106 and MPE supervisory processor 204. This may allow for remote, real-time control of individual MPEs 100 and simultaneous control of multiple MPEs 100 with appropriate limitations for safety. It may also allow for real-time alerting and centralized scheduling and planning of maintenance tasks. Other functions, such as plant configuration management, trending, and plant supervisory control may be entirely centralized and accessible via client 106.

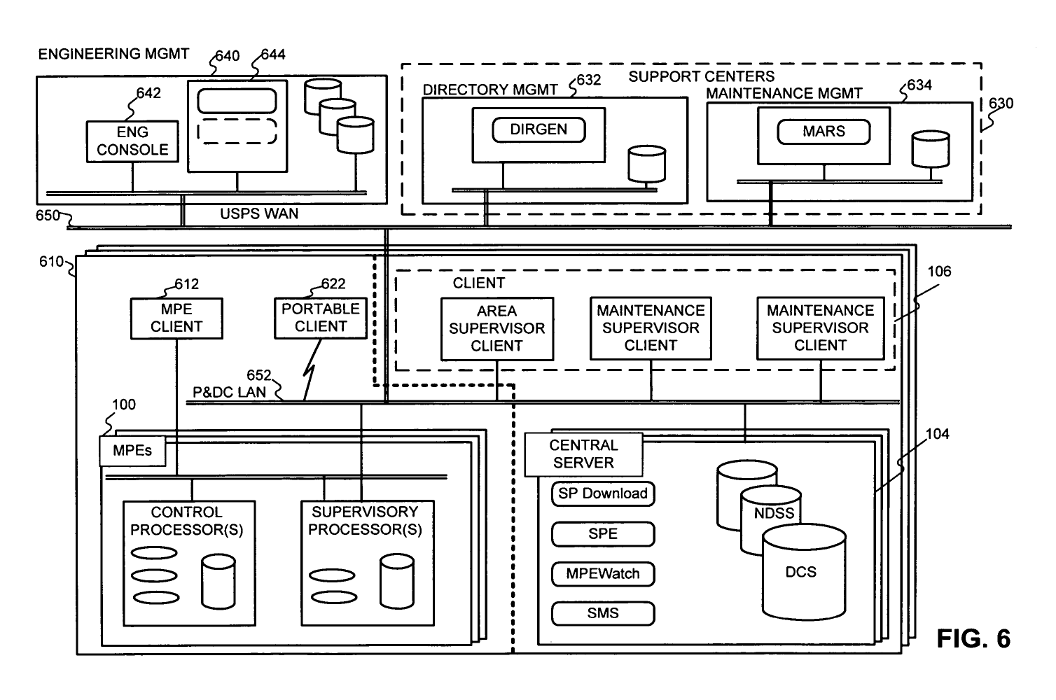

FIG. 6 illustrates an exemplary centralized mail processing system consistent with the present invention. A processing and development center (“P&DC”) 610 may contain one or more MPEs 100, an MPE client 612, a collection of central servers 104, clients 106, support centers 630, and a central location, such as an engineering management center 640, connected in a network configuration or WAN configuration represented by USPS WAN 650 and P&DC local area network (LAN) 652. Engineering management center 640 may collect and manage statistical reports and performance reports using statistical report server 644, ENG console 642, and one or more databases. Support centers 630 may include directory management center 632 and maintenance management center 634, which may manage maintenance information for MPEs. Support centers 630 may also include an optical character recognition center (not shown).

MPE 100 may send event information to central server 104 via P&DC LAN 652. The event information may be accessible to client 106 as well as MPE client 612. Portable client 622 may also access all event information available to client 104 and MPE client 612. Event information may include any data generated by control processor 202, supervisory processor 204, or optical character recognition systems available on each MPE 100. For example, many MPEs 100 may capture the image of addresses from pieces of mail. Client 106 may then contain an optical character recognition system and a national directory database 302 of addresses to look up the destination of each piece of mail. Client 106 may then send the destination code back to MPE 100, which may sort the mail based on that information. This system may eliminate the need for each MPE 100 to have its own copy of an optical character recognition program and its own national directory database of addresses.

Client 106 may be located in a control room, separate from the plant floor. This remote location may prevent dust from entering the computer hardware and breaking it.

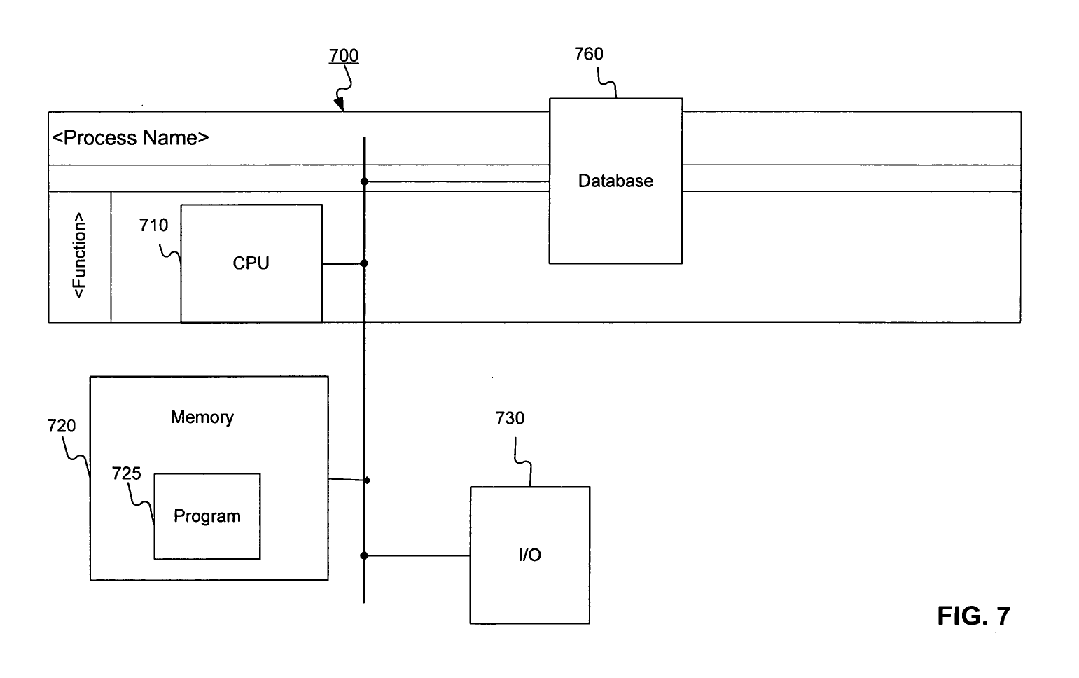

FIG. 7 illustrates an exemplary computing system 700 consistent with embodiments of the invention. The specific components and arrangement, however, are not critical to the present invention.

System 700 may include a number of components, such as a central processing unit (CPU) 710, a memory 720, an input/output (I/O) device(s) 730, and a database 760, all of which may be implemented in various ways. For example, an integrated platform (such as a workstation, personal computer, laptop, etc.) may comprise CPU 710, memory 720 and I/O devices 730. In such a configuration, components 710, 720, and 730 may connect through a local bus interface. Access to database 760 (implemented as a separate database system) may be facilitated through a direct communication link, a LAN, a WAN and/or other suitable connections. The database system's server may consist of network storage architecture and blade-based technology. System 700 may be part of a larger MPE system that networks several similar systems to perform processes and operations consistent with the invention.

CPU 710 may be one or more known processing devices, such as a microprocessor from the Pentium™ family manufactured by Intel™. Memory 720 may be one or more storage devices configured to store information used by CPU 710 to perform certain functions related to embodiments of the present invention. Memory 720 may be a magnetic, semiconductor, tape, optical, or other type of storage device. In one embodiment consistent with the invention, memory 720 includes one or more programs 725 that, when executed by CPU 710, perform processes and operations consistent with the present invention. For example, memory 720 may include a program 725 that accepts and processes mailpiece tracking information, or memory 720 may include an MPE fault management program 725, or memory 720 may include mailpiece sort program 725, or an optical character recognition program 725.

Methods, systems, and articles of manufacture consistent with the present invention are not limited to programs or computers configured to perform dedicated tasks. For example, memory 720 may be configured with a program 725 that performs several functions when executed by CPU 710. That is, memory 720 may include a program 725 that performs monitoring functions, optical character recognition functions, and other functions, such as receipt of alarm and events related to operational performance of an MPE. Alternatively, CPU 710 may execute one or more programs located remotely from system 700. For example, system 700 may access one or more remote programs that, when executed, perform functions related to embodiments of the present invention.

Memory 720 may also be configured with an operating system (not shown) that performs several functions well known in the art when executed by CPU 710. By way of example, the operating system may be Microsoft Windows™, Unix™, Linux™, an Apple Computers operating system, Personal Digital Assistant operating system such as Microsoft CE™, or other operating system. The choice of operating system, and even the use of an operating system, is not critical to the invention.

I/O device 730 may comprise one or more input/output devices that allow data to be received and/or transmitted by system 700. For example, I/O device 730 may include one or more input devices, such as a keyboard, touch screen, mouse, scanner, microphone, communications port, and the like, that enable data to be input from a user. Further, I/O device 730 may include one or more output devices, such as a display screen, CRT monitor, LCD monitor, plasma display, printer, speaker devices, communications port, and the like, that enable data to be output or presented to a user. The configuration and number of input and/or output devices incorporated in I/O device 730 are not critical to the invention.

Database 760 may comprise one or more databases that store information and are accessed and/or managed through system 700. By way of example, database 760 may be an Oracle™ database, a Sybase™ database, or other relational database. Systems and methods of the present invention, however, are not limited to separate databases or even to the use of a database, as data can come from practically any source, such as the internet and other organized collections of data.

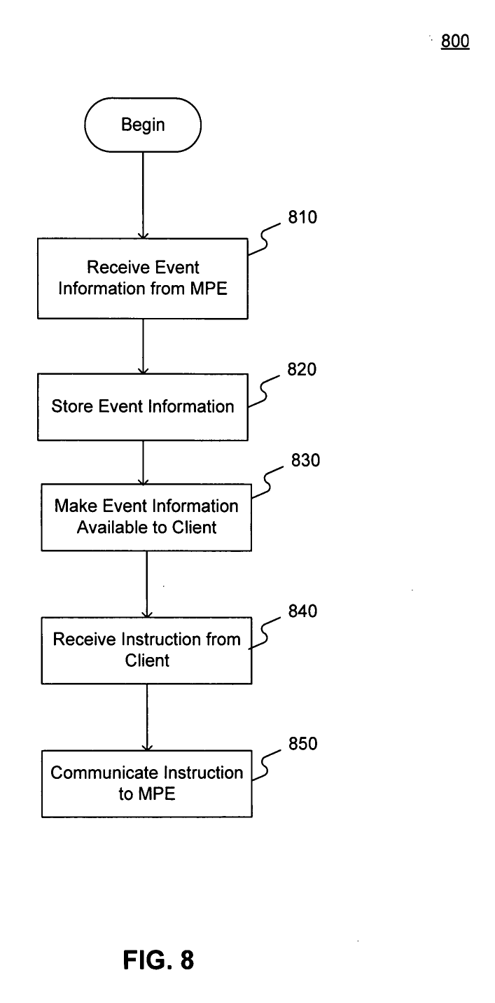

In an exemplary embodiment shown in FIG. 8, central server 104 performs the steps of procedure 800 to process event information. Central server 104 may receive event information from one or more MPEs 100 (step 810). Event information may include any MPE performance data, mailpiece tracking alerts, or historical data related to MPEs 100 and plant operation in general. For instance, event information may include the address of any machine that accesses a network, a machine jam alarm, or a machine status summary. Event information may also include the severity level of the event (e.g., critical, non-critical, warning, etc.) with which a component of the automation equipment is associated, an alarm type, a change of condition (e.g., a jam has cleared, a machine resumed operation, etc.), transition information (e.g., a run has stopped, a run has started, etc.). Event information may include machine status data and metadata transmitted from MPE 100 via a connection oriented network communication protocol, such as a time stamp, error code, machine status, and other data.

Central server 104 may store the event information (step 820) and deliver the event information to client 106 (step 830). Central server 104 may receive an instruction from client 106 regarding the event information (step 840) and communicate the instruction to one or more MPEs 100 (step 850), through a near real-time interface protocol. A control flow may be used for an automated application, for example to evaluate operating plan goals, monitor machine, plant, and inter-plant performance indicators, determine if performance is meeting goals, and take needed action (e.g., start new machines, modify sort plans, etc.).

A unified system architecture may allow centralized and high-level control of MPEs 100. Interfaces may enable the flow of data between local supervisory functions such as operations control and maintenance control, stored in MPEs 100, and centralized supervisory functions such as planning and certain configurations for operations and maintenance, stored in central server 104 or client 106. The centralized management architecture may comprise plant and enterprise servers. Plant servers may comprise, for example, DCS 300, a sort plan server, a directory server, and a central server 104.

The system architecture may provides a framework, independent of how the system architecture is implemented, for describing the systems of the mail processing plant as a collection of MPEs 100, central servers 104, and clients 106 interconnected and interoperating via a set of protocols. To most effectively create a unified system architecture, common hardware, common software, common data, and common user interfaces may be provided among other elements. The system architecture may allow for uniform methods of describing and accessing information, facilities for extending information types, mechanisms to describe and navigate basic relationships, and support for defining associated presentation information. The system architecture may consist of three primary components, the service-oriented architecture model, information model, and communications model.

The service-oriented architecture model may be the hardware platform on which each system 700 is run, along with the software that is used to run it. The communications model then may allow the systems 700 to interface with each other. The information model may enable the flow of data between systems 700, allowing for a choice of how data will be presented to users.

By way of example, the system architecture may be based on the OPC Unified Architecture framework. The service-oriented architecture model may make the information of the plant equipment and operations available via central servers 104. It may be based on, for example, an interface description language, MMS specifications and profile documents, or XML technology and the SOAP protocol. The communications model preferably separates a service interface from a service implementation, allowing for the usage of other protocols and encodings, such as binary encodings, without requiring modifications of the user code. Systems and methods of the present invention, however, are not limited to any particular framework.

The information model may provide a framework for organizing information from MPEs 100 within and potentially across processing plants. This framework and the underlying data transport mechanisms may help to facilitate exchange and understanding of data between plant floor equipment and plant and enterprise management applications. The architecture may allow for uniform methods of describing and accessing information, facilities for extending information types, mechanisms to describe and navigate basic information relationships, and support for defining associated presentation information. The information model may have three main integrated sub-models: an address space sub-model, an object sub-model, and a services sub-model.

The address space sub-model may allow the user to find and use the functions that are centralized that would otherwise be localized on each MPE 100. Thus, the address space sub-model may visually show how all of the machines' functions have been consolidated onto one machine. The address space may be structured hierarchically, with nodes that form a tree structure in the address space. Node identifiers may identify the location of specific nodes within a server. Node identifiers may consist of a namespace identifier, an identifier type, and an identifier value. Identifier types may be, for example, numeric, globally unique identifiers, universal resource identifiers, path names, data type identifiers, or opaque identifiers. The address space may be partitioned through the use of branch nodes. The address space may then be represented visually using a simple hierarchical depiction suitable for browsing.

The object sub-model may define objects as a collection of attributes, or variables, and associated methods, or commands. Objects may support general read/write access to variables and properties and may provide notifications of property changes and command, alarm, and event notifications.

The services sub-model may allow requests, responses, and event notifications to be conveyed between clients and servers through the exchange of messages. Clients may subscribe to event notifications that are based on alarms, data value changes, tracking events, simple events, or command execution events.

Overall, the information model may provide a set of capabilities that are suitable for a wide range of servers, including a single MPE 100 and many different types of central servers 104. Profiles may be used to define the subsets of the overall information space that are appropriate to the central servers 104.

Besides possible division into the address space, object, and services sub-models, the information model may also, separately, be divided into the machine sub-model and the site sub-model. The machine sub-model is a structure for describing and decomposing the physical and logical components of the plant equipment. This information may be structured to meet the needs of operations and maintenance staff. The site sub-model may be a structure for describing and decomposing the operations flow of mail pieces through the plant. This information may be structured to meet the needs of management staff as they predict, for example, volumes versus equipment and staff availability to meet the needs of the operating plan. Standardized data element definitions may underlie both sub-models. These definitions may provide common naming and usage conventions.

The machine sub-model may be used for describing MPE network-visible components. The machine sub-model may define components of MPEs 100 in terms of, for example, modules, blocks, variables, and algorithms. Variables may define the network-visible elemental parameters of an MPE 100. Blocks may represent physical or logical partitions of an MPE 100.

The site sub-model may provide a site-wide view of the plant. It may define general site information such as site identifier, location, regions, associated plants, and other information, and it may provide a container for structuring the views associated with operating, planning, and maintenance perspectives.

Reliability and recovery of the system architecture may become increasingly important as functionality and data are distributed and accessed throughout a plant. At the MPE level, spooling of event streams may provide a mechanism to ensure recoverability of data transmitted via event streams. On the system level, the Unified Architecture may provide several reliability features. For instance, a keep-alive feature may provide for early detection of disruptions. Another feature may allow clients and servers to rapidly recover sessions and state contexts. Message sequence numbers may allow tracking of which messages have been received. Channel resynchronization may allow seamless transfer across redundant components.

The system architecture preferably includes software that provides data access, alarms and events, and historical data access. The software preferably defines an interface for using each of these features. The Unified Architecture preferably provides enterprise integration, improves reliability, and fixes some problems with previous technologies.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of centralized processing and management of information, comprising:
monitoring, at a central server, mail processing equipment;
receiving, at the central server, at least one of performance and event information from the mail processing equipment;
making at least one of the event information and the performance information available to a client;
receiving, from the client, at the central server, an instruction related to the information; and
communicating at least one of the instruction, the event information, and the performance information to the mail processing equipment.

2. The method of claim 1, wherein the client comprises an input/output device

3. The method of claim 2, wherein the input/output device comprises at least one handheld device for control and monitoring.

4. A system for centralized processing and management of information, comprising:
mail processing equipment;
a central server comprising:
a receiver configured to receive at least one of performance and event information from the mail processing equipment;
a database configured to store the information; and
a transmitter configured to make available the information; and
a client comprising an interface configured to receive the information and communicate instructions over a network.

5. The system of claim 4, wherein the mail processing equipment comprises more than one piece of equipment.

6. The system of claim 5, wherein two or more pieces of mail processing equipment run on the same operating system.

7. The system of claim 4, wherein the mail processing equipment has a computing environment and a memory.

8. The system of claim 7, wherein the memory permanently stores data.

9. The system of claim 8, wherein the memory transmits data.

10. The system of claim 7, wherein the memory temporarily stores data and later transmits it.

11. The system of claim 4, wherein the central server further comprises more than one piece of equipment.

12. The system of claim 4, wherein the central server is located remotely from the mail processing equipment.

13. The system of claim 4, wherein the client further comprises more than one piece of equipment.

14. The system of claim 4, wherein the client further comprises a handheld device.

15. The system of claim 4, wherein the client is located remotely from the mail processing equipment.

16. The system of claim 4, wherein the client further comprises:
a configuration management application configured to view and/or modify configuration settings of the mail processing equipment;
a planning application configured to compare plant and/or intra-plant performance indicators against at least one of plant and logistics operating plans; and
a fault management application configured to receive alarms related to the mail processing equipment.

17. The system of claim 16, wherein the planning application is further configured to alert management when operations deviates from plan.

18. The system of claim 4, wherein the client further comprises a thin client.

19. The system of claim 4, wherein the client further comprises a thick client.

20. The system of claim 4, wherein the client further comprises a smart client.

21. The system of claim 4, wherein the mail processing equipment, the central server, and the client can all access event information.

22. The system of claim 21, wherein the mail processing equipment, the central server, and the client can communicate by a network.

23. The system of claim 22, wherein the mail processing equipment, the central server, and the client can communicate by a local area network.

24. The system of claim 22, wherein the mail processing equipment, the central server, and the client can communicate by a wide area network.

25. The system of claim 21, wherein a separate plant can access the event information.

26. The system of claim 4, wherein at least one of the mail processing equipment, the central server, and the client run on a single operating system.

27. The system of claim 4, wherein a central location collects statistical operating data on at least one of the mail processing equipment, the central server, and the client.

28. The system of claim 4, wherein a support center manages at least one of the mail processing equipment, the central server, and the client.

29. The system of claim 4, wherein at least one of the mail processing equipment, the central server, and the client further comprises:
a central processing unit;
a memory;
an input/output device; and
a database.

30. A computer-readable medium including instructions for performing a method of centralized processing of information, the method comprising:
monitoring, at a central server, mail processing equipment;
receiving, at the central server, at least one of performance and event information from the mail processing equipment;
making the information available to a client;
receiving, from the client, an instruction related to the information; and
communicating the instruction to the mail processing equipment.
